(19) United States
(12) Patent Application Publication
(10) Pub. No.: US 2021/0050732 A1
(43) Pub. Date: Feb. 18, 2021

(54) Mobile Device Charging Bar Caddy

(71) Applicant: Interactive Marketing Corporation, North Haven, CT (US)

(72) Inventor: Robert J. Caldarella, Branford, CT (US)

(21) Appl. No.: 16/541,364

(22) Filed: Aug. 15, 2019

(51) Int. Cl. H02J 7/00; G09F 23/06; G02F 1/133

(52) U.S. Cl. CPC H02J 7/0027; H02J 7/0044; H02J 2007/0062; G02F 1/133; G09F 23/06

(57) ABSTRACT

A mobile device charging bar caddy includes a caddy housing with at least one receptacle adapted to accommodate drink accessories, such as napkins and straws. The bar caddy includes a plurality of charging connectors for mobile devices, such as smartphones, that are extendable away from the housing when needed, and retractable into the housing when not in use. The housing also includes a power supply electrically connected to the charging connectors such that the power supply supplies power to the mobile device when the charging connector is connected to the mobile device. A base portion smaller than the main housing protrudes from the bottom of the main housing so that the caddy can be mounted in a drink rail. In some cases, the caddy includes various connector types for accommodating different phones.

### FIELD OF THE INVENTION

The present invention relates to bar caddies for drinking establishments. More specifically, the invention relates to a bar caddy with retractable cords for charging mobile devices.

### BACKGROUND OF THE INVENTION

As is well known, drinking establishments that serve alcoholic and other beverages, such as pubs, taverns, and saloons, typically have as a defining characteristic a long countertop where the drinks are served, usually referred to as a “bar.” This bar is generally of limited width, such that the patrons of the establishment and the bartenders serving those patrons are able to easily converse with one another and hand drinks and methods of payment across the bar. Additionally, these bars often have a drink rail (sometimes referred to as a gutter or well), which is a recessed area along the rear of the bar (closest to the bartender), which further limits the amount of usable countertop space.

As a result, these bars, which are generally highly coveted areas where patrons of these establishments congregate, present a very limited amount of highly desirable space. Many other types of establishments that serve drinks, such as restaurants and clubs, also often have a “bar area” that includes one or more bars, which frequently tend to be among the most crowded areas of those establishments. Hence, these bars are extremely common, but typically very valuable, pieces of real estate in countless social settings.

A common problem for patrons of drink establishments is that their portable devices often run out of power while they are there. Patrons not only bring portable devices such as smartphones, tablets, and laptop computers, but they often actively use these devices while they are at the drinking establishment. Sometimes, this is simply for work or leisure, such as when one is travelling and attending to business on their laptop while at the bar. However, increasingly, the use of mobile devices, and smartphones in particular, has become an integral part of the social activities taking place at these establishments. When socializing at a bar, patrons will often use their smartphone to take photos of themselves and others, to post these pictures and comments to various social media platforms and actively monitor and respond to comments thereto, to collectively participate in games such as trivia, word puzzles, and the like, collectively research questions or information online that arise during their conversations, and even collectively call or video chat with others.

All of these activities tend to rapidly drain the battery life of the smartphone (or other mobile) device, sometimes causing the device to run out of power while the patron is still at the establishment. This can be especially problematic today, when many of these patrons need to also later use the smartphone for critical activities, such as obtaining transport home via a driving service, obtaining directions, or receiving calls from babysitters. Unfortunately, most establishments do not even provide power outlets accessible to the patrons, much less supply the additional charging equipment necessary to charge their devices.

This results in disadvantages to the patron, who may have to forego using their mobile devices for the aforementioned social activities in order to conserve power, or may have to leave early before their device runs out of power, or may find themselves in a compromising situation if their mobile device does indeed run out of power. This also results in disadvantages for the owners and tip-earning employees of these establishments, who will lose business when patrons leave earlier than they otherwise would have because those patrons are concerned about their devices losing power or because they are not having as enjoyable of an experience as they otherwise could be with the full use of their device.

Though occasionally bartenders will take a mobile phone and charge it for the patron, this is uncommon for several reasons. Often, they are not allowed to do so because the establishment does not want to be responsible for any damage. Also, this is often undesirable for the user, who is not able to continue using the device while it is being charged.

[000s] A main reason drinking establishments usually do not provide outlets and chargers right on the bar for customer use is due to the aforementioned valuable real estate. Accordingly, it has been suggested to incorporate a charging station into a bar caddy that would already be occupying some of the counter space. For example, U.S. Patent Application No. 2018/0337538 by Zemel et al. describes a multi-purpose caddy station, with traditional receptacles for napkins and straws. The bottom front of this caddy includes multiple USB ports, into which patrons can insert a charging cord. As a result, the drinking establishment is able to provide a station for the multiple patrons to charge their multiple devices that does not sacrifice precious bar top real estate.

One problem with this type of device, however, is that patrons rarely have a charging cord. While most people who actively rely on a mobile phone typically have their phones with them at all times, people almost never have charging cords with them. Accordingly, the type of device described in Zemel will usually be useless to almost all patrons.

Accordingly, it has been suggested to use such a bar caddy with built-in cords. For example, one such device is the BarConic® Bar Top Charging Station. This device has a number of charging cords connected to the front of a bar caddy. As a result, assuming it has the right connections, patrons are able to plug in their mobile devices for charging even though they don't have charging cords with them.

However, this type of device suffers from a number of disadvantages. The charging cords connected to the front of the caddy have to lay on the surface of the bar, which causes several problems. Most importantly, the cords take up a significant amount of room, and as noted above, due to the high value of the limited countertop space, this is highly undesirable. Additionally, the bar is constantly getting covered in the beverage liquids splashing out of glasses or running down the sides thereof due to overfilling by bartenders. As result, the cords are constantly getting sticky and difficult to keep clean. This can be further exacerbated by the fact that, in many cases, food is also often served on the bar countertops. Finally, because the cords are just lying on the countertop, they are prone to damage.

Additionally, while incorporating charging mechanisms into a caddy helps to save space on the bar, the caddy itself takes up significant room. Moreover, the caddy itself sometimes has to compete for space with drink menus or advertising materials that the drinking establishment wants to position of the countertop.

What is desired, therefor, is a bar caddy that is able to charge mobile devices without patrons needing to have their own charging cord. What is further desired is a bar caddy that minimizes the amount of countertop space used and is easy to keep clean. What is also desired is such a bar caddy that does not have to compete for space with other common bar countertop devices.

### SUMMARY OF THE INVENTION

Accordingly, it is an object of the present invention to provide a bar caddy that eliminates the need for a separate charging cord.

It is also an object of the present invention to provide a bar caddy that does not utilize a large amount of bar countertop space to accommodate charging cords.

It is a further object of the present invention to provide a bar caddy that also does not utilize a large amount of main countertop space to accommodate the caddy itself.

It is yet another object of the present invention to provide a bar caddy that incorporates other display items that would typically be provided separately on a bar countertop.

In order to overcome the deficiencies of the prior art and to achieve at least some of the objects and advantages listed, the invention comprises a mobile device charging bar caddy, including a bar caddy housing with at least one receptacle adapted to accommodate drink accessories, at least one retractable charging connector configured to connect to a mobile device to transfer power thereto, wherein the charging connector is extendable away from the housing and retractable towards the housing, and a power supply electrically connected to the at least one retractable charging connector such that the power supply supplies power to the mobile device when the charging connector is connected to the mobile device.

In certain advantageous embodiments, bar caddy housing has a main body section from the which the at least one retractable housing connector extends, the main body section having a bottom, and a base section protruding downwardly from the bottom of the main body section, wherein the base section is smaller than the main body section and adapted to fit in a drink rail such that a portion of the main body section extends over a bar top in front of the drink rail.

In some embodiments, the charging connector is extendable to a plurality of lengths at which retraction towards the housing is inhibited, and in advantageous embodiments, is retractable to a fully retracted position by pulling the connector away from the housing and releasing the connector.

In certain embodiments, wherein the charging connector has a first end that remains outside the housing when the charging connector is in the fully retracted position.

In certain advantageous embodiments, the charging connector includes a retractable coiling cord device disposed in the housing. In some of these embodiments, the retractable coiling cord device includes a rotating disc, and a cord coiled around the rotating disc, the cord having a first cord portion that extends out through a wall of the housing and has a first end extendable away from the housing and configured to connect to the mobile device, and a second cord portion in the housing with a second end electrically connected to the power supply.

In some of these embodiments, the wherein the retractable coiling cord device includes a spiral spring seated in the rotating disc.

In certain embodiments, the second cord portion is detachably connected to the power supply.

In certain advantageous embodiments, the at least one retractable charging cord connector includes a plurality of retractable charging cord connectors, the plurality of connectors including at least two different connector types.

In some embodiments, the at least one retractable charging cord includes at least one lightning connector. In some cases, the at least one retractable charging cord includes at least one microUSB connector. In some embodiments, the at least one retractable charging cord includes at least one USB-C connector.

In certain embodiments, comprising at least one phone platform hingedly connected to at least one side the housing such that the platform pivots from a folded position to an unfolded position, the platform configured to support a cellular phone placed thereon when in the unfolded position. In some of these embodiments, the platform has a charging surface for wirelessly charging the cellular phone when the cellular phone is placed on the platform.

In certain advantageous embodiments, further comprising at least one phone receptacle protruding from at least one side of the housing and configured to accommodate at least part of a cellular phone therein, the phone receptacle having a charging surface therein for wirelessly charging the cellular phone when the at least part of the cellular phone is disposed in the phone receptacle.

In some embodiments, the at least one exterior wall of the housing includes an advertising display In some of these embodiments, the display is a dynamic display screen with a wireless network adaptor for wirelessly receiving data to be displayed on the screen. In some cases, the display screen is a liquid crystal display.

In certain embodiments, the at least one receptacle includes first and second side receptacles and a middle receptacle larger than the side receptacles.

### BRIEF DESCRIPTION OF THE DRAWINGS

FIG. 1 is a front perspective view of a bar caddy according to the invention.

FIG. 2 is a front perspective view of the bar caddy of FIG. 1 with a display charging several smartphones.

FIG. 3 is a top view of the bar caddy of FIG. 1 with the inner cover removed.

FIG. 4 is an exploded perspective view of a retractable coiling cord device of the bar caddy of FIG. 1.

FIG. 5 is a rear perspective view of the bar caddy of FIG. 1.

FIG. 6 is a partially cross-sectional side view of the bar caddy of FIG. 1 mounted in a drink rail.

### DETAILED DESCRIPTION OF THE INVENTION

The following detailed description illustrates the technology by way of example, not by way of limitation, of the principles of the invention. This description will enable one skilled in the art to make and use the technology, and describes several embodiments, adaptations, variations, alternatives and uses of the invention, including what is presently believed to be the best mode of carrying out the invention. One skilled in the art will recognize alternative variations and arrangements, and the present technology is not limited to those embodiments described hereafter.

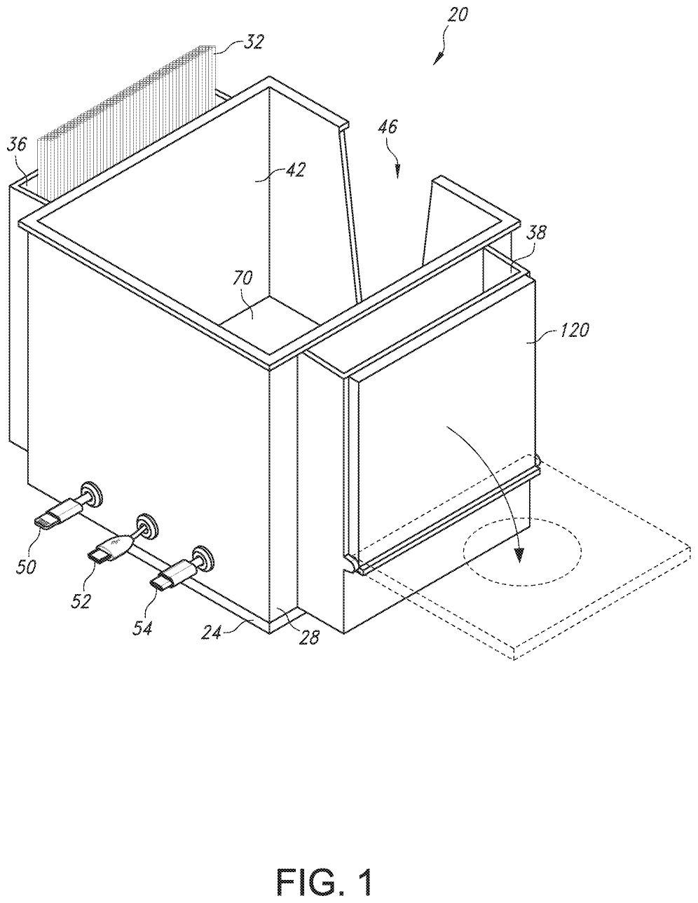

FIG. 1 illustrates one exemplary embodiment of a bar caddy (20) in accordance with the invention. The housing of the bar caddy (20) has a main section (24) and base section (28). The main section (24) includes one or more receptacles for drink accessories (32), such as napkins, straws, and the like. For example, in some embodiments, the housing includes first and second side receptacles (36), (38) for accommodating stirring straws, and a center receptacle (42) larger than first and second receptacles (36), (38) for holding napkins, which includes a tapered opening (46) at the back to facilitate easy insertion and removal of the napkins.

The bar caddy (20) includes one or more retractable charging connectors that are each configured to connect to a mobile device, such as a smartphone. In advantageous embodiments, there are a plurality of charging connectors (50), (52), (54), such that multiple mobile devices can be charged at the same time. Though the connectors may all be of the same type, in some cases, this plurality of connectors includes at least two different connector types in order to accommodate different devices, such as different generations of an iPhone, or smartphones made by different manufacturers. For example, the charging connectors (50), (52), and (54) may include a lightning connector, a microUSB connector, and a USB-C connector.

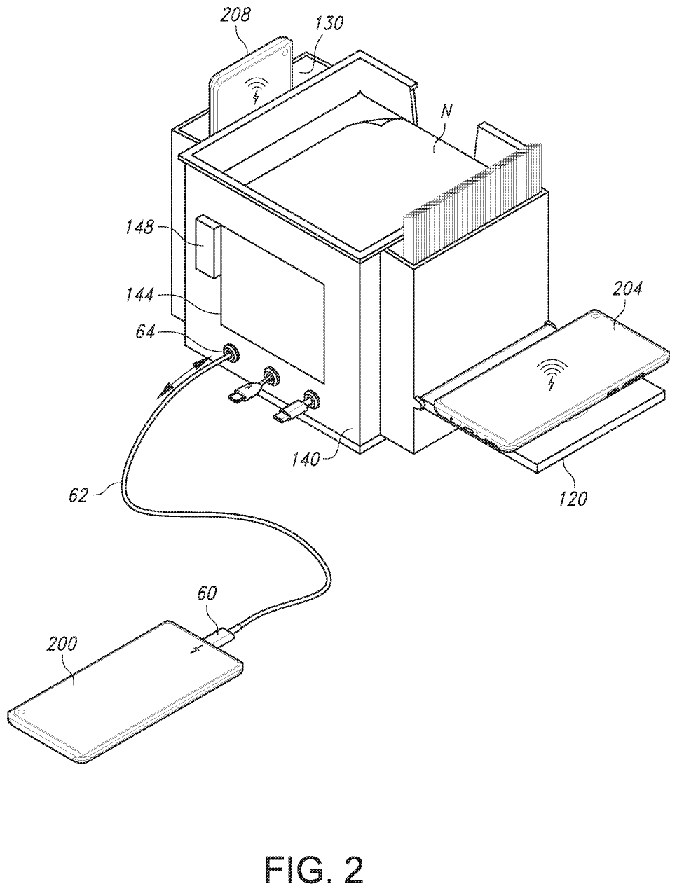

Referring to FIGS. 1-2, each retractable charging connector (50) is extendable away from the housing (28) such that it can be conveniently connected to the device (200) so that a smartphone can be laid flat on the bar top or held in a user's hand to allow continuous use of the phone while charging. The charging connector (50) has a first end (60) that is configured to connect to the mobile device (200) and that remains outside the housing (28) even when the charging connector is in a fully retracted position. A cord (62) passes through a port (64) on the front of the housing (28) and into a lower chamber covered by a flat, removable cover (70), as further explained below.

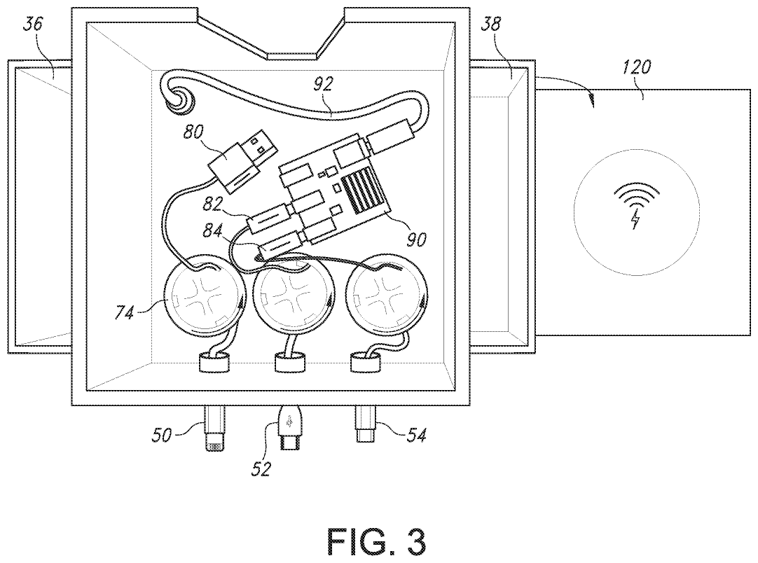

Turning to FIG. 3, the lower chamber of the housing (with the removeable cover removed) is illustrated. Within the normally concealed lower chamber of the housing (28), the cord (62) extends from a retractable coiling cord device (74) secured inside the housing. The retractable coiling cord device (74) can be of any suitable compact design, such as, for example, the multi-stage retractable coiling cord device disclosed in U.S. Pat. No. 6,871,812 to Chang, the specification of which is hereby incorporated by reference herein in its entirety.

The other end of the cord (62) is connected to a power supply that supplies power to the charging connector (50). Though this can be a permanent connection, in advantageous embodiments, it is detachably connected, such that a retractable coiling cord device can be removed without any rewiring. For example, in some cases, the end of the cord (62) has a connector, such as a standard USB A connector (80), that plugs into a circuit board (90). As a result, a single power cord (92) connected to the circuit board (90) can supply power to all three USB connectors (80), (82), (84) plugged into the board (90). In this way, power can be supplied to all three mobile device connectors (50), (52), (54) corresponding to the USB connectors (80), (82), (84).

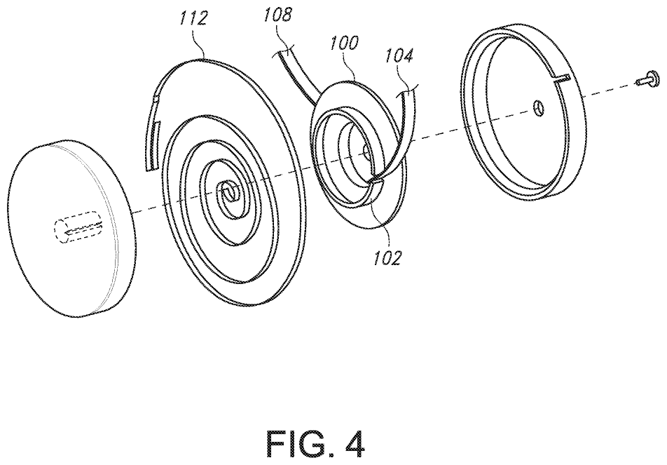

As shown in FIG. 4, in some embodiments, each retractable coiling cord device (74) includes a rotating disc (100), which the cord (62) is coiled around. A first cord portion (104) is extendable and retractable through the front of the housing (28), and a second cord portion (108) is electrically connected to the power supply (90), (92), as previously described. A spiral spring (112) is seated within a circumferential wall of the rotating disc (100), and the second cord portion (108) is secured to the rotating disc (100) such that the first cord portion (104) can be freely coiled and uncoiled around the rotating disc (100). Each rotation of the rotating disc (100) facilitates an incremental locking of the cord, such that the coiling cord device (74) acts as a ratcheting mechanism to allow the first cord portion (104) to be extended away from the housing (28) by pulling it to various distances, and inhibiting retracting towards the housing (28) at incremental distances from the housing (28). The charging connector (50) is retractable to a fully retracted position by gently pulling the charging connector first end (60) away from the housing and releasing it.

Returning to FIGS. 1-2, in some cases, the bar caddy (20) further includes a wireless charging platform (120). The wireless charging platform is hingedly connected to a wall of the housing (28) or receptacle (38), such that it can remain in a folded position when not in use in order to save space. When needed, it can be pivoted downwardly into an unfolded position, and a phone (204) can be placed thereon for wireless charging. This likewise allows for continued use of the phone while charging, and has the additional advantage of preventing spillage of drinks on the phone. Additionally, the wireless charging platform (120) allows for charging when a patron's phone has a connection port that does not correspond to any of the types of the available charging connectors (50), (52), (54).

Additionally, in some embodiments, one or more of the receptacles (36), (38) include a wireless charging surface (130), such that a phone (208) can be deposited therein. While this does not enable continuous use of the phone, it is nevertheless useful when a large number of phones need to be simultaneously charged.

In some versions of the bar caddy (20), the exterior wall (140) of the housing (28) includes an advertising display. For example, the display may be an LCD screen (144) with a wireless network adaptor (148) connected thereto so that the screen can connect to a wireless network. As a result, data can continually be sent to the screen to produce a dynamic display and provide customized advertising.

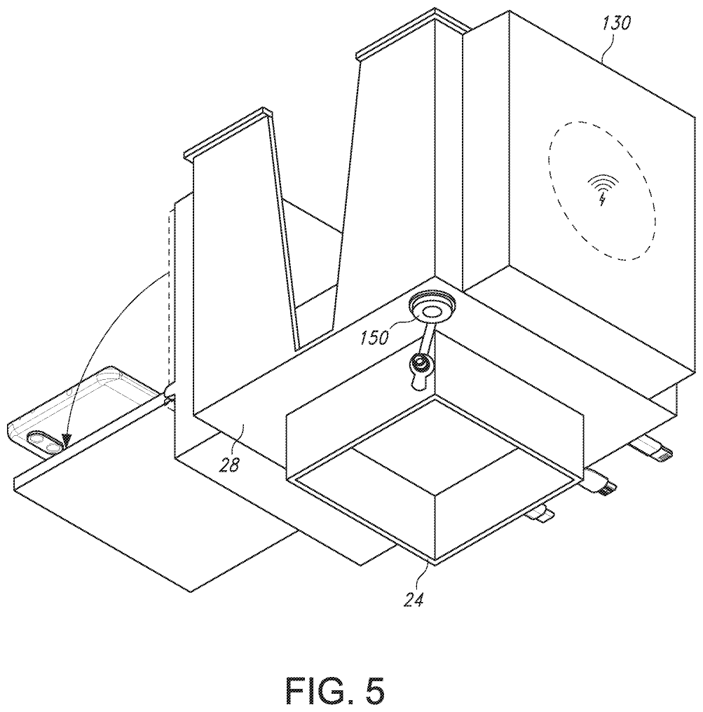

Referring to FIG. 5, the underside of the bar caddy (20) is illustrated. As shown, the housing (28) includes an electrical input port (150) for plugging in a power source (such as cord from a wall socket) to supply power to the internal power supply cord (92) described above. It should be noted, however, that in some embodiments, an onboard battery could be employed, either as a backup power source or as a main power source.

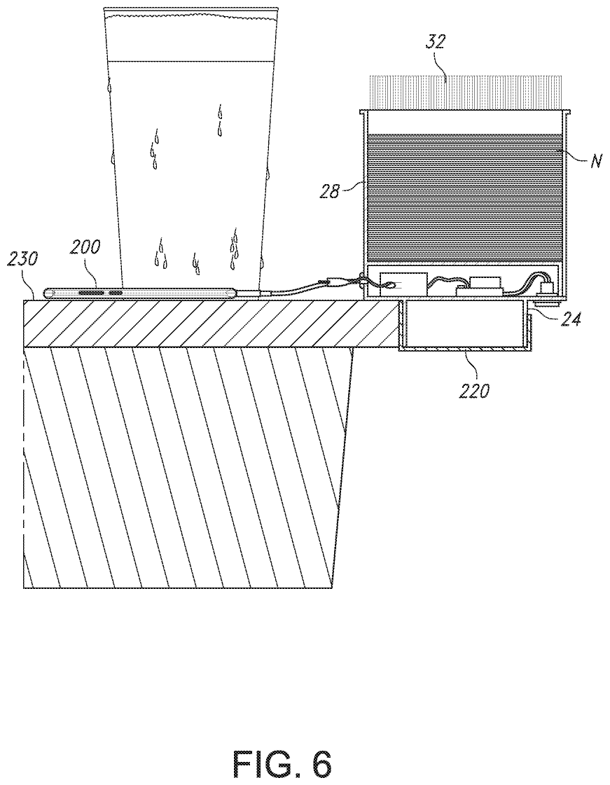

The base section (24) is smaller than, and protrudes from the bottom of, the main section (28) of the housing. As shown in FIG. 6, this permits the bar caddy (20) to reside mostly in a drink rail (220). The base section (24) is smaller than the main section (28) and adapted to fit in the drink rail (220), such that a portion of the main section (28) extends over the bar top (230) in front of the drink rail to securely seat the bar caddy. In this way, significant bar countertop space is saved.

It should be understood that the foregoing is illustrative and not limiting, and that obvious modifications may be made by those skilled in the art without departing from the spirit of the invention. Although the invention has been described with reference to embodiments herein, those embodiments do not limit the scope of the invention. Accordingly, reference should be made primarily to the accompanying claims, rather than the foregoing specification, to determine the scope of the invention.

What is claimed is:

1. A mobile device charging bar caddy, comprising:
a bar caddy housing with at least one receptacle adapted to accommodate drink accessories;
at least one retractable charging connector configured to connect to a mobile device to transfer power thereto, wherein the charging connector is extendable away from the housing and retractable towards the housing; and
a power supply electrically connected to the at least one retractable charging connector such that the power supply supplies power to the mobile device when the charging connector is connected to the mobile device.

2. The mobile device charging bar caddy of claim 1, wherein the bar caddy housing comprises:
a main body section from the which the at least one retractable housing connector extends, the main body section having a bottom; and
a base section protruding downwardly from the bottom of the main body section, wherein the base section is smaller than the main body section and adapted to fit in a drink rail such that a portion of the main body section extends over a bar top in front of the drink rail.

3. The mobile device charging bar caddy of claim 1, wherein the charging connector is extendable to a plurality of lengths at which retraction towards the housing is inhibited.

4. The mobile device charging bar caddy of claim 3, wherein the charging connector is retractable to a fully retracted position by pulling the connector away from the housing and releasing the connector.

5. The mobile device charging bar caddy of claim 4, wherein the charging connector has a first end that remains outside the housing when the charging connector is in the fully retracted position.

6. The mobile device charging bar caddy of claim 4, wherein the charging connector comprises a retractable coiling cord device disposed in the housing.

7. The mobile device charging bar caddy of claim 6, wherein the retractable coiling cord device includes:
a rotating disc;
a cord coiled around the rotating disc, the cord having:
a first cord portion that extends out through a wall of the housing and has a first end extendable away from the housing and configured to connect to the mobile device; and
a second cord portion in the housing with a second end electrically connected to the power supply.

8. The mobile device charging bar caddy of claim 7, wherein the retractable coiling cord device comprises a spiral spring seated in the rotating disc.

9. The mobile device charging bar caddy of claim 7, wherein the second cord portion is detachably connected to the power supply.

10. The mobile device charging bar caddy of claim 1, wherein the at least one retractable charging cord connector comprises a plurality of retractable charging cord connectors, the plurality of connectors including at least two different connector types.

11. The mobile device charging bar caddy of claim 1, wherein the at least one retractable charging cord comprises at least one lightning connector.

12. The mobile device charging bar caddy of claim 1, wherein the at least one retractable charging cord comprises at least one microUSB connector.

13. The mobile device charging bar caddy of claim 1, wherein the at least one retractable charging cord comprises at least one USB-C connector.

14. The mobile device charging bar caddy of claim 1, further comprising at least one phone platform hingedly connected to at least one side the housing such that the platform pivots from a folded position to an unfolded position, the platform configured to support a cellular phone placed thereon when in the unfolded position.

15. The mobile device charging bar caddy of claim 14, wherein the platform comprises a charging surface for wirelessly charging the cellular phone when the cellular phone is placed on the platform.

16. The mobile device charging bar caddy of claim 1, further comprising at least one phone receptacle protruding from at least one side of the housing and configured to accommodate at least part of a cellular phone therein, the phone receptacle having a charging surface therein for wirelessly charging the cellular phone when the at least part of the cellular phone is disposed in the phone receptacle.

17. The mobile device charging bar caddy of claim 1, wherein at least one exterior wall of the housing includes an advertising display.

18. The mobile device charging bar caddy of claim 1, wherein the display comprises a dynamic display screen with a wireless network adaptor for wirelessly receiving data to be displayed on the screen.

19. The mobile device charging bar caddy of claim 1, wherein the display screen comprises a liquid crystal display.

20. The mobile device charging bar caddy of claim 1, wherein the at least one receptacle comprises first and second side receptacles and a middle receptacle larger than the side receptacles.
